(19) United States
(12) Patent Application Publication
(10) Pub. No.: US 2024/0370785 A1
(43) Pub. Date: Nov. 7, 2024

(54) Navigation Guidance For A Vehicle To A Region Which Satisfies Criteria Of A Utility Function

(71) Applicant: Google LLC, Mountain View, CA (US)

(72) Inventors: Yan Mayster, Aurora, CO (US); Robert Bruce Bahnsen, Boulder, CO (US)

(21) Appl. No.: 18/247,335

(22) PCT Filed: Jul. 13, 2022
(86) PCT No.: PCT/US2022/036958

§ 371 Date: Mar. 30, 2023

(51) Int. Cl. G06Q 10/047; G01C 21/34; G01C 21/36; G06Q 30/0201

(52) U.S. Cl. CPC G06Q 10/047; G01C 21/3415; G01C 21/3453; G01C 21/3605; G06Q 30/0201

(57) ABSTRACT

A method for providing navigation guidance for a vehicle includes identifying a first region among a plurality of regions as a region which satisfies criteria of a utility function with respect to offerings associated with a vehicle and providing navigation guidance for the vehicle to the first region, via a navigation device. The method further includes determining, based on one or more real-time conditions at the first region and a second region among the plurality of regions, whether the first region or the second region is a region which satisfies the criteria of the utility function with respect to an availability of the offerings associated with the vehicle. When the second region is determined as the region which satisfies the criteria of the utility function based on the determining, the navigation guidance provided for the vehicle is changed from the first region to the second region, via the navigation device.

### FIELD

The disclosure relates generally to providing navigation guidance for a vehicle. More particularly, the disclosure relates to methods and computer systems for implementing navigation guidance for a vehicle to a region which satisfies criteria of a utility function, for example, based on real-time conditions at the region and with respect to offerings associated with the vehicle.

### BACKGROUND

Recent events such as the pandemic have resulted in an increase in online shopping and requests for deliveries of goods and services to a user's home or place of business. Vehicles, for example delivery vehicles, may be used to deliver the goods and services to customers according to order placements from the customers. Deliveries of goods and services in this manner may be considered reactive in nature as the deliveries are made in response to an order from a customer.

### SUMMARY

Aspects and advantages of embodiments of the disclosure will be set forth in part in the following description, or can be learned from the description, or can be learned through practice of the example embodiments.

In one or more example embodiments, a computer-implemented method includes identifying a first region among a plurality of regions as a region which satisfies criteria of a utility function with respect to offerings associated with a vehicle, providing navigation guidance for the vehicle to the first region, via a navigation device, determining, based on one or more real-time conditions at the first region and a second region among the plurality of regions, whether the first region or the second region is a region which satisfies the criteria of the utility function with respect to an availability of the offerings associated with the vehicle, and when the second region is determined as the region which satisfies the criteria of the utility function based on the determining, changing the navigation guidance provided for the vehicle from the first region to the second region, via the navigation device.

In some implementations, when the first region is determined as the region which satisfies the criteria of the utility function based on the determining, the method includes determining for the vehicle to continue to or remain at the first region.

In some implementations, the method includes when the second region is determined as the region which satisfies the criteria of the utility function based on the determining, autonomously controlling the vehicle to navigate to the second region, and when the first region is determined as the region which satisfies the criteria of the utility function based on the determining, autonomously controlling the vehicle to remain at the first region.

In some implementations, the method includes determining a navigation route which sequentially passes through two or more regions among the plurality of regions, wherein each of the two or more regions are determined as regions among the plurality of regions as regions which satisfy the criteria of the utility function with respect to the availability of the offerings associated with the vehicle based on a first sequence of travel, and in response to at least one of the offerings being provided to one or more users at one of the two or more regions, determining whether to change the navigation route to a second sequence of travel based on a remaining availability of the offerings associated with the vehicle.

In some implementations, when the remaining availability of the offerings associated with the vehicle is below a threshold level, determining to change the navigation route to the second sequence of travel.

In some implementations, whether the criteria of the utility function is satisfied is based on at least one of an expected profit to be obtained at each region among the plurality of regions per unit of a predetermined period of time, an expected revenue to be obtained at each region among the plurality of regions per unit of the predetermined period of time, a cost associated with traveling to each region among the plurality of regions, or a cost associated with remaining in each region among the plurality of regions for the predetermined period of time.

In some implementations, the one or more real-time conditions include at least one of current traffic conditions on one or more routes from the first region to the second region, current weather conditions at each of the first region and the second region, current events occurring at each of the first region and the second region, a current predicted consumer population density at each of the first region and the second region, or current foot traffic conditions at each of the first region and the second region.

In some implementations, the plurality of regions correspond to one or more road segments in a predefined area, one or more grid cells associated with a map of the predefined area, or one or more locations at which the vehicle is permitted to provide the offerings to one or more users.

In some implementations, the method includes, in response to the vehicle remaining at the first region for a predetermined period of time, determining based on the one or more real-time conditions at the first region and the second region, whether the first region or the second region is a region which satisfies the criteria of the utility function with respect to the availability of the offerings associated with the vehicle.

In some implementations, the offerings include at least one of goods or services, and the method further includes providing the at least one of the goods or services to one or more users at the first region by: when the offerings include one or more goods, in response to a selection of the one or more goods via a user interface, causing the vehicle to dispense the one or more goods to the one or more users, or when the offerings include one or more services, in response to a selection of the one or more services via the user interface, causing the vehicle to authorize the one or more services to be performed for the one or more users.

In some implementations, in response to a rate of the offerings being provided to one or more users at the first region per unit of time being less than a threshold level, determining whether the first region or the second region is a region which satisfies the criteria of the utility function with respect to the availability of the offerings associated with the vehicle.

In some implementations, identifying the first region among the plurality of regions as the region which satisfies the criteria of the utility function with respect to the offerings associated with the vehicle is based on a history of instances of providing the offerings to users at the first region.

In one or more example embodiments, a computer system is provided. The computer system may include one or more memories to store instructions, and one or more processors configured to execute the instructions stored in the one or memories to: identify a first region among a plurality of regions as a region which satisfies criteria of a utility function with respect to offerings associated with a vehicle, provide navigation guidance for the vehicle to the first region, via a navigation device, determine, based on one or more real-time conditions at the first region and a second region among the plurality of regions, whether the first region or the second region is a region which satisfies the criteria of the utility function with respect to an availability of the offerings associated with the vehicle, and when the second region is determined as the region which satisfies the criteria of the utility function based on the determination, change the navigation guidance provided for the vehicle from the first region to the second region, via the navigation device.

In some implementations, the one or more processors are configured to, when the first region is determined as the region which satisfies the criteria of the utility function, determine for the vehicle to continue to or remain at the first region.

In some implementations, the one or more processors are configured to: when the second region is determined as the region which satisfies the criteria of the utility function based on the determination, autonomously control the vehicle to navigate to the second region, and when the first region is determined as the region which satisfies the criteria of the utility function based on the determination, autonomously control the vehicle to remain at the first region.

In some implementations, the one or more processors are configured to: determine a navigation route which sequentially passes through two or more regions among the plurality of regions, wherein each of the two or more regions are determined as regions among the plurality of regions as regions which satisfy the criteria of the utility function with respect to the availability of the offerings associated with the vehicle based on a first sequence of travel, and in response to at least one of the offerings being provided to one or more users at one of the two or more regions, determine whether to change the navigation route to a second sequence of travel based on a remaining availability of the offerings associated with the vehicle.

In some implementations, the one or more processors are configured to, when the remaining availability of the offerings associated with the vehicle is below a threshold level, determine to change the navigation route to the second sequence of travel.

In some implementations, the one or more processors are configured to: in response to receiving a query from a user requesting a route to distribute a set amount of offerings stocked in the vehicle in a set duration of time, determine based on the one or more real-time conditions at the first region and the second region, whether the first region or the second region is a region which satisfies the criteria of the utility function with respect to the query, and determine a route for the vehicle to one of the first region or the second region, based on the determination with respect to the query.

In some implementations, the one or more processors are configured to: in response to the vehicle remaining at the first region for a predetermined period of time, determine based on the one or more real-time conditions at the first region and the second region, whether the first region or the second region is a region which satisfies the criteria of the utility function with respect to the availability of the offerings associated with the vehicle, and in response to a rate of the offerings being provided to one or more users at the first region per unit of time being less than a threshold level, determine based on the one or more real-time conditions at the first region and the second region, whether the first region or the second region is a region which satisfies the criteria of the utility function with respect to the availability of the offerings associated with the vehicle.

In one or more example embodiments, a vehicle is provided. The vehicle may include a navigation device and a computer system which is configured to: identify a first region among a plurality of regions as a region which satisfies criteria of a utility function with respect to offerings associated with the vehicle, provide navigation guidance for the vehicle to the first region, via the navigation device, determine, based on one or more real-time conditions at the first region and a second region among the plurality of regions, whether the first region or the second region is a region which satisfies the criteria of the utility function with respect to an availability of the offerings associated with the vehicle, and when the second region is determined as the region which satisfies the criteria of the utility function based on the determination, change the navigation guidance provided for the vehicle from the first region to the second region, via the navigation device.

In some implementations, the computing system may be configured to, when the first region is determined as the region which satisfies the criteria of the utility function, determine for the vehicle to continue to or remain at the first region.

In some implementations, the vehicle may be a partially autonomous or a fully autonomous vehicle.

In some implementations the computing system is configured to perform one or more operations of any of the operations of any of the computing systems described herein.

In one or more example embodiments, a computer-readable medium (e.g., a non-transitory computer-readable medium) which stores instructions that are executable by one or more processors of a computing system is provided. The instructions may include instructions to cause the one or more processors to: identify a first region among a plurality of regions as a region which satisfies criteria of a utility function with respect to offerings associated with a vehicle, provide navigation guidance for the vehicle to the first region, via a navigation device, determine, based on one or more real-time conditions at the first region and a second region among the plurality of regions, whether the first region or the second region is a region which satisfies the criteria of the utility function with respect to an availability of the offerings associated with the vehicle, and when the second region is determined as the region which satisfies the criteria of the utility function based on the determination, change the navigation guidance provided for the vehicle from the first region to the second region, via the navigation device.

In some implementations, the computer-readable medium stores instructions which may include instructions to, when the first region is determined as the region which satisfies the criteria of the utility function, cause the one or more processors to determine for the vehicle to continue to or remain at the first region.

In some implementations the computer-readable medium stores instructions which may include instructions to cause the one or more processors to perform one or more operations of any of the methods described herein or to perform one or more operations of any of the computing systems described herein.

These and other features, aspects, and advantages of various embodiments of the disclosure will become better understood with reference to the following description, drawings, and appended claims. The accompanying drawings, which are incorporated in and constitute a part of this specification, illustrate example embodiments of the disclosure and, together with the description, serve to explain the related principles.

### BRIEF DESCRIPTION OF THE DRAWINGS

Detailed discussion of example embodiments directed to one of ordinary skill in the art is set forth in the specification, which makes reference to the appended drawings, in which:

FIG. 1 depicts an example system, according to one or more examples of the disclosure;

FIG. 2 depicts example block diagrams of a computing system and a server computing system, according to one or more examples of the disclosure;

FIG. 3A depicts a first example route for distributing offerings associated with a vehicle, according to one or more examples of the disclosure;

FIG. 3B depicts a second example route for distributing offerings associated with a vehicle, according to one or more examples of the disclosure;

FIG. 4 illustrates an example flow diagram for generating a route for distributing offerings associated with a vehicle, according to one or more examples of the disclosure; and

FIG. 5 illustrates an example flow diagram of a non-limiting computer-implemented method according to one or more examples of the disclosure.

### DETAILED DESCRIPTION

Reference now will be made to embodiments of the disclosure, one or more examples of which are illustrated in the drawings, wherein like reference characters denote like elements. Each example is provided by way of explanation of the disclosure and is not intended to limit the disclosure. In fact, it will be apparent to those skilled in the art that various modifications and variations can be made to the disclosure without departing from the scope or spirit of the disclosure. For instance, features illustrated or described as part of one embodiment can be used with another embodiment to yield a still further embodiment. Thus, it is intended that the disclosure covers such modifications and variations as come within the scope of the appended claims and their equivalents.

Terms used herein are used to describe the example embodiments and are not intended to limit and/or restrict the disclosure. The singular forms “a,” “an” and “the” are intended to include the plural forms as well, unless the context clearly indicates otherwise. In this disclosure, terms such as “including”, “having”, “comprising”, and the like are used to specify features, numbers, steps, operations, elements, components, or combinations thereof, but do not preclude the presence or addition of one or more of the features, elements, steps, operations, elements, components, or combinations thereof.

It will be understood that, although the terms first, second, third, etc., may be used herein to describe various elements, the elements are not limited by these terms. Instead, these terms are used to distinguish one element from another element. For example, without departing from the scope of the disclosure, a first element may be termed as a second element, and a second element may be termed as a first element.

The term “and/or” includes a combination of a plurality of related listed items or any item of the plurality of related listed items. For example, the scope of the expression or phrase “A and/or B” includes the item “A”, the item “B”, and the combination of items “A and B”.

In addition, the scope of the expression or phrase “at least one of A or B” is intended to include all of the following: (1) at least one of A. (2) at least one of B, and (3) at least one of A and at least one of B. Likewise, the scope of the expression or phrase “at least one of A, B, or C” is intended to include all of the following: (1) at least one of A. (2) at least one of B. (3) at least one of C. (4) at least one of A and at least one of B, (5) at least one of A and at least one of C. (6) at least one of B and at least one of C, and (7) at least one of A, at least one of B, and at least one of C.

Examples of the disclosure are directed to providing navigation guidance (e.g., determining navigation routes) for a vehicle which optimizes the distribution (e.g., by satisfying criteria of a utility function) of offerings (e.g., goods and services) associated with the vehicle, according to real-time conditions including geographic and dynamic event information, and according to an availability of the offerings associated with the vehicle. More particularly, according to example embodiments a computing system may identify a first region as a region among a plurality of regions which satisfies criteria of a utility function with respect to the offerings associated with the vehicle, and navigation guidance may be provided for the vehicle to travel to the first region (e.g., via a navigation device). For example, the first region may be identified as satisfying the criteria of the utility function (e.g., by maximizing the utility function) when it is determined that the expected revenue or expected profit will be greatest by the vehicle traveling to the first region compared to the other regions among the plurality of regions. In addition, the computing system may subsequently determine whether the criteria of the utility function will continue to be satisfied by remaining at the first region or by traveling to another region (e.g., a second region) among the plurality of regions with respect to an availability of the offerings associated with the vehicle. When the second region is identified as the region which satisfies the criteria of the utility function based on real-time conditions at the first region and the second region and based on the availability of the offerings, navigation guidance may be provided for the vehicle to the second region (e.g., via the navigation device). When the first region is identified as the region which satisfies the criteria of the utility function, the vehicle may remain at the first region. The computing system may correspond to a computing system for a vehicle and may include a navigation system of the vehicle, a server computing system which includes one or more servers, a computing system of an electronic device such as a smartphone, etc., or combinations thereof.

In some implementations, the computing system may determine a region (e.g., an optimal region) among the plurality of regions which satisfies the criteria of the utility function, in response to an offering being provided via the vehicle. In some implementations, the computing system may determine at periodic intervals a region (e.g., an optimal region) among the plurality of regions which satisfies the criteria of the utility function. In some implementations, the computing system may determine a region (e.g., an optimal region) among the plurality of regions which satisfies the criteria of the utility function, in response to the vehicle remaining at the first region for a duration of time greater than a predetermined duration of time. In some implementations, the computing system may determine a region (e.g., an optimal region) among the plurality of regions which satisfies the criteria of the utility function, in response to a rate of the offerings being provided to one or more users at the first region per unit of time being less than a threshold level. For example, if revenue is not being generated after a predetermined amount of time at a region (e.g., after ten minutes, twenty minutes, etc.), or if offerings are provided at a slow rate at a region (e.g., sales of a product are slow such as if a number of product offerings sold per hour is less than a threshold sales level, if an amount of revenue or profit earned per hour is less than a threshold revenue/profit level, etc.), the computing system may be configured to determine whether another region among the plurality of regions satisfies the criteria of the utility function.

Determining a region which satisfies (or is predicted to satisfy) the criteria of the utility function may be based on various factors and may be based on information previously collected, information collected in real-time, and information which is predicted or expected.

For example, computer systems (e.g., navigation systems, sales platforms, etc.) associated with delivery vehicles may accumulate data regarding previous orders and routes, for example regarding reactive transactions where a user places an order, or regarding proactive transactions which are described herein. For example, the data may include information about goods carried by the vehicle or services offered via the vehicle, price information associated with the goods or services (e.g., a sales price, a cost of the goods, a profit margin, etc.). For example, the data may include geographic information (e.g., address information, region information, etc.) associated with orders for the goods where the delivery vehicle delivers the goods. For example, the data may include navigation information (e.g., route information, travel times, travel costs, etc.) associated with orders for the goods where the delivery vehicle delivers the goods. The data accumulated by delivery vehicles may be stored (e.g., in a database, a memory, etc.) by a computing system.

In contrast to the reactive sales discussed above, examples of the disclosure are directed to a computing system which is configured to perform proactive navigation planning and routing that is based on a prediction for providing offerings to users located at various regions who have not placed orders (but may be considered as potential customers), based on the data accumulated by delivery vehicles from previous transactions (e.g., previous reactive and/or proactive transactions) as well as other real-time and dynamic information concerning the various regions. For example, the computing system may predict that traveling to a first region among a plurality of regions to provide offerings to users at the first region is likely to be more profitable than traveling to a second region among the plurality of regions. Traveling to a region which is determined or predicted to result in a maximum profit relative to traveling to other regions may satisfy the criteria of the utility function. For example, the computing system may predict that traveling to a first region among a plurality of regions to provide offerings to users at the first region is likely to result in the greatest exposure for a product or service compared to traveling to a second region among the plurality of regions. Traveling to a region which is determined or predicted to result in the greatest exposure relative to traveling to other regions may satisfy the criteria of the utility function.

For example, the computing system may determine a route for a vehicle (e.g., a vending vehicle) based on: (1) regions which are considered the busiest (e.g., having a high volume of people in the region, having high foot traffic in the region, having a high volume of people who consume the goods and services offered via the vehicle, etc.), (2) regions which are considered profitable (e.g., regions which are predicted to and/or have previously generated the highest revenue with respect to the goods and services associated with the vehicle, regions which are predicted to and/or have previously generated the highest profit with respect to the goods and services associated with the vehicle, etc.), (3) costs associated with traveling to each region along the route (e.g., fuel costs, taxation costs, costs associated with parking, etc.), (4) time considerations (e.g., the predicted time to travel to each region along the route while considering revenue and/profit which could be generated if not for the travel time, (5) real-time conditions such as a current time, weather, event scheduling in each region, traffic conditions, etc., and (6) past reactive and proactive shopping histories of users in each region. The computing system may be remotely disposed from the vehicle, for example as part of a server computing system and/or as part of an electronic device such as a smartphone. In some implementations, the computing system may be disposed at or integrated with the vehicle. In some implementations, portions of the computing system may be disposed at the vehicle and other portions of the computing system may be remotely disposed. For example, the computing system (or a portion of the computing system) may be integrated with a navigation system of the vehicle. Therefore, the navigation system of the vehicle may perform some or all of the operations of the computing system described herein. For example, the navigation system may receive information relating to a region to be travelled to, and the navigation system may provide the navigation guidance for the vehicle using a navigation device such as a Global Positioning Sensor (GPS) device. For example, the computing system may determine real-time conditions at various regions based on information received from various sensors disposed at the regions, or may obtain real-time conditions at various regions from other sources such as a website, social media, etc.

In some implementations the vehicle may be driven by a human and the vehicle and/or human is provided navigation guidance via the computing system regarding the route which is determined by the computing system. In other implementations the vehicle may be an autonomous vehicle (e.g., possibly with a human monitor) which is provided the navigation guidance via the computing system regarding the route which is determined by the computing system. In some implementations the autonomous vehicle may be remotely controlled via the computing system to follow the route determined by the computing system.

In some implementations, a region which the vehicle travels to along the determined route may correspond to a geographic area such as a road segment, a neighborhood, a parking lot, a specific address, a grid cell on a map (e.g., 1 km×1 km area), and the like. For example, some roads may include designated special lanes and some venues (e.g., concert halls, stadiums, schools, churches, etc.) may designate special parking areas for vehicles to park. The computing system may include these designated areas as one of the plurality of regions to which the vehicle may travel to. In some implementations, specially designated areas located close to venues or specially designated lanes located along a road segment may be given greater weight than other regions which are not specially designated for parking of a vehicle which provides offerings to customers.

The computing system may identify a region which satisfies criteria of a utility function (e.g., maximizes a utility function) such that a user trying to provide offerings associated with the vehicle may query the computing system for an optimal region(s) by asking the computing system: “Tell me where to send my vehicle associated with goods A, B, and C and services D, E, and F, so they will sell quickly and at the best price.” The computing system may utilize various algorithms described in more detail later to find such a region or sequence of regions. The computing system is configured to take into account various product payloads, which could be anything from sandwiches to phones or services such as haircutting services, massage services, advertising services, legal services, banking services, etc. The computing system may store a mapping of products to a market segment formed by customers likely to purchase these products (e.g., the computing system can determine which products sell best in particular regions such as near university campuses, retirement homes, movie theatres, etc.). The computing system also can store a mapping of an expected or measured number of customers with respect to particular regions based on knowledge of traffic patterns, any special events occurring at each region, a time of day (e.g., times when students are released from school or when people travel to work or home). For example, the computing system can predict a number of people expected to be at a particular region based on previous data in a similar context (e.g., a similar time of day, weather, etc.) or social media information, or the computing system can measure a number of people at a particular region based on real-time data such as from data obtained from one or more cameras at the region which can capture images of people located at the region, or from information obtained from mobile devices carried by people in the region that can indicate a number of people at the region, etc.

In response to a query from the user, the computing system may determine a route for the vehicle to travel to one or more regions to provide the offerings associated with the vehicle to users at each of the one or more regions. In addition, the computing system may determine a time at which the vehicle should arrive at each region, as well as a duration of time the vehicle should spend at each region before traveling to another region. In some implementations, the query from the user may request a route which is optimized to sell all of the offerings associated with the vehicle. In some implementations, the query from the user may request a route which is optimized to sell a particular number of offerings associated with the vehicle. In some implementations, the query from the user may be a voice query and specify a particular timeframe in which to sell all of the offerings associated with the vehicle (e.g., “Tell me a route to sell all of my ice cream in the next three hours”), or the user may specify a particular timeframe in which to sell a particular number of offerings associated with the vehicle (e.g., “Tell me a route where I can provide three haircuts in the next three hours”). For example, in some implementations, in response to receiving a query from a user, the computing system may determine based on one or more real-time conditions at the first region and the second region, whether the first region or the second region is a region which satisfies criteria of a utility function with respect to an availability of the offerings associated with the vehicle. In some implementations, the computing system may automatically determine (i.e., without receiving a query or request from the user) a route based on a known (e.g., current) availability of offerings associated with the vehicle. In some implementations, the query by the user may be input through an input device (e.g., via a graphical user interface, text query, etc.) other than an input device using voice recognition technology.

For example, the computing system may leverage information which is collected concerning reactive transactions as well as concerning proactive transactions, to determine the route based on the query from the user. For example, the information may include route histories to route vehicles along the best routes (e.g., having the highest exposure to customers, or having the highest sales yield, etc.), or information concerning route histories for vehicles having particular payloads that are similar to or identical to a payload of a vehicle which requests a route or are similar to or identical to an inventory of a user who wishes to optimally stock and/or fuel a vehicle before sending the vehicle out. The information may also include information about past order deliveries of vehicles, including payload information, pricing information, delivery time information, delivery success/failure information, travel time information, etc. Such information may then be aggregated by region (which may correspond to a road segment, neighborhood, grid cell, etc., as discussed above), and categorized (e.g., by product category, by time, by brand, etc.). The computing system may then leverage some or all of the above-described information to determine a route for a vehicle so as to satisfy the criteria of the utility function (e.g., by optimizing an exposure to customers, by maximizing an expected revenue and/or profit, etc.), with respect to the offerings associated with the vehicle.

In some implementations, the computing system may have access to a variety of semantic information which can be used to determine a navigation route for distributing offerings associated with the vehicle in an optimal manner. For example, known map data may include knowledge regarding business density, building heights, parking lots, road width, the presence of sidewalks, known busy venues, educational institutions, parks, etc. Such information may be used by the computing system to infer the location of office towers, green spaces, apartment blocks, etc. Such information may also be used by the computing system to indicate or infer a “busyness” level and vending potential, such as for locations previously unvisited or with insufficient data to seed a routing algorithm. For example, the computing system may determine not to route a vehicle to a road segment having a width less than a predetermined threshold width. For example, the computing system may determine not to route a vehicle to a road segment unless the road segment has a specially designated lane for parking the vehicle.

For example, the computing system may access or obtain information related to any events which may be occurring in each of the regions. For example, the computing system may access or obtain information relating to events which could or have resulted in road closures or traffic jams and may adjust a navigation route accordingly. In some implementations, the computing system may send the vehicle to a region having such an event with a large gathering of people that are likely to purchase the offerings associated with the vehicle. The events may include concerts, movie showings, sporting events, etc., and the computing system may optimize the arrival and departure times of the vehicle to coincide with the start and end times of such events (e.g., appropriately buffered by some time interval to provide the offerings before and after the event). For example, if a football game is at 7 pm at a particular stadium and ends at 10 pm, the computing system may determine that location as a region which is highly profitable (e.g., which satisfies the criteria of the utility function) between 6:30 pm and 7:15 pm and between 9:45 pm and 10:30 pm, and treat these time periods appropriately when planning overall routing for the vehicle that day.

The computing system may utilize various algorithms to determine a navigation route which satisfies the criteria of the utility function (e.g., maximizes the utility function) with respect to the distribution of offerings provided via the vehicle. In some implementations, the computing system may calculate a route in a “greedy” algorithm fashion. For example, in the case of providing advertising services via the vehicle, the algorithm may be implemented to achieve a highest exposure, enforcing some minimum exposure time at a region and taking into account the diminishing returns of overstaying at a particular region, with the overall benefit computed as the sum of the products of the number of people P and a marginal utility function of the number of minutes of exposure to them (i.e., being in the vicinity of N meters to each predicted population Pi): Sum (Pi*U (Ti)). In the case of providing goods via the vehicle, the algorithm may be implemented to optimize for the highest likely sales total (e.g., maximizing revenue, maximizing profit, etc.), which also depends on the exposure time (i.e., when the vehicle is in a non-moving parked state) and takes into account the diminishing returns of overstaying at the same location. The utility function in each case can then be computed based on the total sales of similar products at or near the region and, over time, can also be based on previous sales from the vehicle (or other similar vehicles).

Furthermore, since the market at some regions may be segmented by brand/product, the utility function may include different weighted components for each individual product brand or category, and, therefore, the routing algorithm implemented by the computing system may factor this in and re-evaluate the expected utility of stopping at each future region after visiting a region and update the route dynamically as the product inventory of the vehicle changes. By way of example, if a certain product is sold out and a future region in the previously planned route was particularly responsive to that product, the utility of visiting that future region may have sufficiently decreased such that the vehicle may no longer need to stop there. Thus, the routing algorithm implemented by the computing system may recompute the route to make any necessary least-cost updates to the route/schedule of the vehicle. The recomputing may occur at various times—for example, each time a product is provided, each time the vehicle leaves a region, at predetermined time intervals, etc.

The computing system may analyze various regions that the vehicle can possibly travel to and determine an optimal route for the vehicle to travel along to satisfy certain utility function criteria with respect to the distribution of offerings associated with the vehicle. For example, existing information regarding transactions may be aggregated as discussed above on a region-by-region basis (e.g., by grid cells of a certain size or by road segment), and broken down by brand, category, etc. Further breakdowns of the transactions may be categorized by time of day, day of week, weekday/weekend, month, etc. so that the computing system can determine a route based on time dependent variations. In some implementations the routing algorithm may be greedy or an approximation to a traveling salesman problem or a max-flow problem (e.g., for cases with labeled road segments compared to region cells/nodes). The computing system may determine an amount of time to stay at a region based on various information such as a volume of previous sales at the region, a weather forecast for the region, event information pertaining to the region, etc. The computing system may also factor in a fixed amount of time per expected transaction at the region when determining the amount of time to stay at a region. Each region among a plurality of regions considered by the computing system for determining a navigation route of the vehicle has both a time cost and an associated sales parameter (e.g., revenue, profit, etc.) which itself is a function of time. The computing system may plan a route for the vehicle to visit a sequence of regions for as long as the derivative (or the second derivative) of sales with respect to time is above a certain threshold. That is, the computing system may determine that the criteria of a utility function are satisfied (e.g., by maximizing the utility function) so long as an instantaneous increase, or rate of increase, in revenue is above a threshold value. The threshold value may initially be set to some fixed value that is predicted to guarantee at least a minimum duration of time at a region, and then be calibrated empirically based on the known transaction times and time intervals between transactions. In some implementations, the computing system may determine a first region among a plurality of regions as satisfying the criteria of the utility function and select the first region as a first destination. The computing system may determine a second region among a plurality of regions (other than the first region) as satisfying the criteria of the utility function (taking into account the expected transactions at the first region) and select the second region as a second destination. The computing system may determine a third region among a plurality of regions (other than the first region and the second region) as satisfying the criteria of the utility function (taking into account the expected transactions at the first region and the second region) and select the third region as a third destination, and so on to determine a route for the vehicle by which the offerings associated with the vehicle can be provided given various constraints (e.g., a certain time period allotted for providing the offerings associated with the vehicle, an amount of fuel available for the vehicle, etc.). However, as discussed above the route can be dynamically recalculated at any time based on a current or remaining availability of the offerings associated with the vehicle, based on real-time conditions and events, based on a rate of sales, etc. In addition, a duration of time spent at each region can be dynamically recalculated at any time based on the current or remaining availability of the offerings associated with the vehicle, based on real-time conditions and events, based on a rate of sales, etc. Thus, the computing system may alter the previously planned sequence of destinations and/or the previously planned duration of time to be spent at each region, to satisfy the criteria of the utility function (e.g., maximize the utility function) according to real-time information available to the computing system.

In accordance with various examples of the disclosure, fixed-location businesses (e.g., which may have seen a decline of in-store customers due to the pandemic) can deploy a vehicle which can provide offerings (e.g., goods and/or services) proactively to meet consumer demand. Proactively providing such offerings to customers reduces network usage and increases available bandwidth of the network because such customers need not utilize the network to place orders for those offerings. Therefore, computing resources are conserved. User experience and satisfaction is also increased by offerings being provided to users quickly and conveniently. Energy usage by vehicles is also decreased according to various aspects of the disclosure. For example, multiple users need not expend fuel (e.g., gas or electricity) to travel to a fixed-location store to obtain offerings. Instead, a single delivery vehicle may provide offerings to many users at various regions. Furthermore, according to various aspects of the disclosure the computing system can compute an optimal route to provide offerings (e.g., in a shortest amount of time and/or at specific times), while also conserving energy traveling from region to region at particular times, rather than traveling aimlessly from region to region and without regard to optimal times for traveling from one region to another. Furthermore, according to various aspects of the disclosure the optimal route allows for the quick distribution of offerings so that the vehicle travel time is minimized, conserving energy consumption of the vehicle. In some implementations, the vehicle may be autonomous and can be controlled to follow the optimal route which is based on satisfying the criteria of a utility function with respect to the offerings associated with the vehicle.

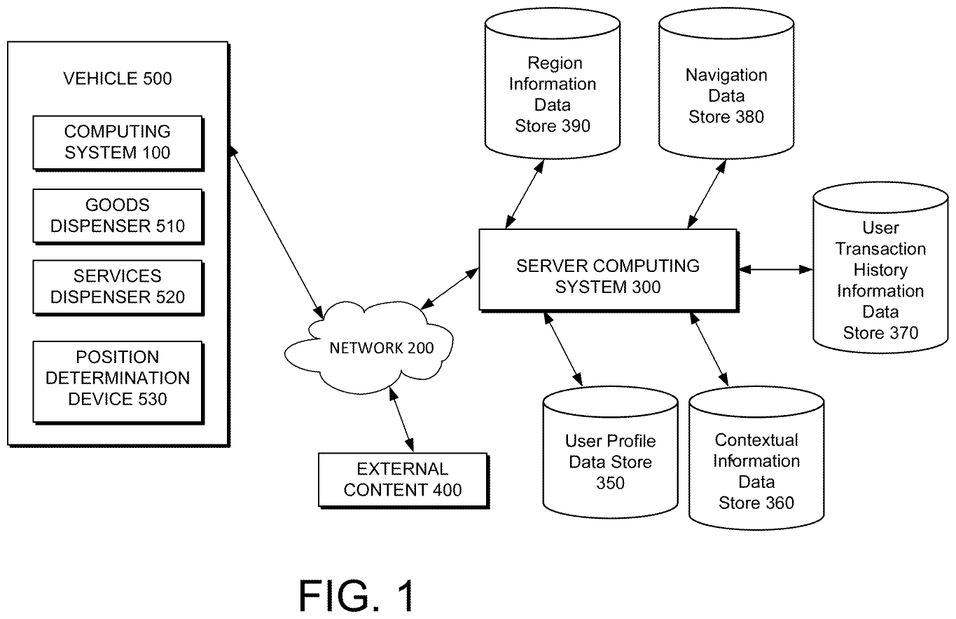

Referring now to the drawings, FIG. 1 is an example system according to one or more example embodiments of the disclosure. FIG. 1 illustrates an example of a system which includes a server computing system 300, external content 400, and a vehicle 500, each of which may be in communication with one another over a network 200.

For example, the network 200 may include any type of communications network such as a local area network (LAN), wireless local area network (WLAN), wide area network (WAN), personal area network (PAN), virtual private network (VPN), or the like. For example, wireless communication between elements of the examples described herein may be performed via a wireless LAN, Wi-Fi, Bluetooth, ZigBee, Wi-Fi direct (WFD), ultra wideband (UWB), infrared data association (IrDA), Bluetooth low energy (BLE), near field communication (NFC), a radio frequency (RF) signal, and the like. For example, wired communication between elements of the examples described herein may be performed via a pair cable, a coaxial cable, an optical fiber cable, an Ethernet cable, and the like. Communication over the network can use a wide variety of communication protocols (e.g., TCP/IP. HTTP, SMTP, FTP), encodings or formats (e.g., HTML, XML), and/or protection schemes (e.g., VPN, secure HTTP, SSL).

For example, the server computing system 300 can include a server, or a combination of servers (e.g., a web server, application server, etc.) in communication with one another, for example in a distributed fashion.

For example, external content 400 can be any form of external content including news articles, webpages, video files, audio files, image files, written descriptions, ratings, game content, social media content, photographs, commercial offers, transportation methods, weather conditions, or other suitable external content. The computing system 100, server computing system 300, and vehicle 500 can access external content 400 over network 200. External content 400 can be searched by the computing system 100, server computing system 300, and vehicle 500 according to known searching methods and search results can be ranked according to relevance, popularity, or other suitable attributes, including location-specific filtering or promotion.

For example, the vehicle 500 can include any vehicle such as an autonomous vehicle, a motor vehicle, railed vehicles, watercraft, aircraft including drones, and the like. The vehicle 500 may be manually driven by a human, a partially autonomous vehicle (e.g., possibly requiring some human assistance or intervention), or may be fully autonomous (e.g., without needing a human driver but may possibly include a human monitor). In some implementations the autonomous vehicle may be remotely controlled via the computing system 100 and/or server computing system 300 to follow a route determined by the computing system 100 and/or server computing system 300. In some implementations the vehicle 500 includes a computing system 100 which is integrated with the vehicle as an onboard device, and which is configured to provide navigation guidance (e.g., determine a navigation routes) for the vehicle 500 which optimizes the distribution (e.g., by satisfying criteria of a utility function) of offerings (e.g., goods and services) associated with the vehicle 500, according to real-time conditions including geographic and dynamic event information, and according to an availability of the offerings associated with the vehicle 500. In other implementations the computing system 100 may be a portable device that is connectable to the vehicle 500 over a network, for example, in a wired or wireless manner. The portable device can include any of a smartphone, a laptop, a tablet computer, and the like. The vehicle 500 may be configured to store goods and to offer services. For example, the vehicle 500 may include a goods dispenser 510 which is configured to vend goods to a user similar to a vending machine in response to an input provided to the vehicle 500 (e.g., via an input device 150 such as a user interface, via an app provided to an electronic device of the user, etc.). The vehicle 500 may also include a services dispenser 520 which is configured to vend services to a user in response to an input provided to the vehicle 500 (e.g., via an input device 150 such as a user interface, via an app provided to an electronic device of the user, etc.). The services may be dispensed by providing a voucher for the services, for example. In some implementations, a human associated with the vehicle 500 may provide a service to a user, such as a haircutting service, massage service, legal service, etc. In other implementations the services may be provided via the computing system 100, for example by enabling a user to obtain legal services, banking services, advertising services, etc., through the computing system 100.

Vehicle 500 may also include a position determination device 530. Position determination device 530 can determine a current geographic location of the vehicle 500 and communicate such geographic location to server computing system 300 over network 200 and to computing system 100 over a wired and/or wireless network. The position determination device 530 can be any device or circuitry for analyzing the position of the vehicle 500. For example, the position determination device 530 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on an IP address, by using triangulation and/or proximity to cellular towers or WiFi hotspots, and/or other suitable techniques for determining a position of the vehicle 500.

In some example embodiments, the server computing system 300 (or the computing system 100) may obtain data from one or more of a user profile data store 350, contextual information data store 360, a user transaction history information data store 370, a navigation data store 380, and a region information data store 390, to implement various operations and aspects of the navigation guidance method described herein. The user profile data store 350, contextual information data store 360, user transaction history information data store 370, navigation data store 380, and region information data store 390 may be integrally provided with the server computing system 300 (e.g., as part of the one or more memory devices 320 of the server computing system 300) or may be separately (e.g., remotely) provided. Further, user profile data store 350, contextual information data store 360, user transaction history information data store 370, navigation data store 380, and region information data store 390 can be combined as a single data store (database) or may be a plurality of respective data stores. Data stored in one data store (e.g., the region information data store 390) may overlap with some data stored in another data store (e.g., the navigation data store 380). In some implementations, one data store (e.g., the region information data store 390) may reference data that is stored in another data store (e.g., the navigation data store 380).

User profile data store 350 can store information regarding one or more user profiles, including a variety of user data such as user preference data, user demographic data, user calendar data, user social network data, user historical travel data, and the like. For example, the user profile data store 350 can include, but is not limited to, email data including textual content, images, email-associated calendar information, or contact information; social media data including comments, reviews, check-ins, likes, invitations, contacts, or reservations; calendar application data including dates, times, events, description, or other content; virtual wallet data including purchases, electronic tickets, coupons, or deals; scheduling data; location data; SMS data; or other suitable data associated with a user account. According to one or more examples of the disclosure, such data can be analyzed by the computing system 100 and/or server computing system 300 to determine or predict potential preferences of users with respect to offerings provided via the vehicle 500 in determining navigation guidance and a navigation route for the vehicle 500 to various regions. According to one or more examples of the disclosure, such data can be analyzed by the computing system 100 and/or server computing system 300 to determine or predict potential locations of users in determining navigation guidance and a navigation route for the vehicle 500 to various regions. For example, such data can be analyzed by the computing system 100 and/or server computing system 300 to determine the amount and type of offerings to supply to the vehicle 500 when determining navigation guidance and a navigation route for the vehicle 500 to various regions.

The user profile data store 350 is provided to illustrate potential data that could be analyzed, in some embodiments, by the computing system 100 and/or server computing system 300. However, such user data may not be collected, used, or analyzed unless the user has consented after being informed of what data is collected and how such data is used. Thus, particular user information stored in the user profile data store 350 may or may not be accessible to the computing system 100 and/or server computing system 300 based on permissions given by the user, or such data may not be stored in the user profile data store 350 at all.

Contextual information data store 360 can store context information associated with previous transactions of users which is accessible by the computing system 100 and/or server computing system 300. For example, the context information may include contextual factors such as time of day, weather, traffic information, and other environmental conditions such as lighting, a noise level, a busyness level, and the like. For example, the context information may be mapped to the previous transactions. For example, the user context information can provide an indication to the computing system 100 and/or server computing system 300 of various conditions in which users are more likely (or less likely) to purchase certain offerings or certain types of offerings. Contextual information data store 360 may also store semantic information which can be used to determine a navigation route for distributing goods and services associated with the vehicle 500 in an optimal manner. For example, known map data may include knowledge regarding business density, building heights, parking lots, road width, the presence of sidewalks, known busy venues, educational institutions, parks, etc. Such information may be used by the computing system 100 and/or server computing system 300 to infer the location of office towers, green spaces, apartment blocks, etc. Such information may also be used by the computing system 100 and/or server computing system 300 to indicate or infer a “busyness” level and vending potential, such as for locations previously unvisited or with insufficient data to seed a routing algorithm. For example, the computing system 100 and/or server computing system 300 may determine not to route the vehicle 500 to a road segment having a width less than a predetermined threshold width. For example, the computing system 100 and/or server computing system 300 may determine not to route the vehicle 500 to a road segment unless the road segment has a specially designated lane for parking the vehicle 500.

User transaction history information data store 370 can store information about previous transactions of users which is accessible by the computing system 100 and/or server computing system 300. For example, the previous transactions can include transactions in which a user reactively placed an order, and a delivery vehicle delivered the order to the user, and transactions in which an order was proactively provided by a vending vehicle corresponding to vehicle 500. For example, the user transaction history information data store 370 may include information about the offerings associated with the delivery vehicle/vehicle 500 such as a brand of the offerings, price information associated with the offerings (e.g., a sales price, a cost of goods, a profit margin, etc.), an amount of the offerings provided in a transaction, time information regarding each transaction, a rate of transactions, etc. For example, the information may include geographic information (e.g., address information or region information) associated with orders for the offerings where the delivery vehicle/vehicle 500 provided the offerings. For example, the information may include a delivery success rate for deliveries to various regions by a delivery vehicle in response to a customer order as well as information regarding an offering success rate at various regions for a vending vehicle such as vehicle 500. For example, the user transaction history information can provide an indication to the computing system 100 and/or server computing system 300 which regions are historically profitable, which regions have users who are more likely to purchase a certain type of offering or brand of offering, which regions have users who purchase offerings at a fastest rate, etc. For example, the computing system 100 and/or server computing system 300 can store a mapping of offerings to a market segment formed by customers that have purchased the offerings or are likely to purchase certain offerings, so that the computing system 100 and/or server computing system can determine which offerings sell best in particular regions such as near university campuses, retirement homes, movie theatres, etc.

Navigation data store 380 may store or provide map data/geospatial data accessible by the computing system 100 and/or server computing system 300. Example geospatial data includes geographic imagery (e.g., digital maps, satellite images, aerial photographs, street-level photographs, synthetic models, etc.), tables, vector data (e.g., vector representations of roads, parcels, buildings, etc.), point of interest data, or other suitable geospatial data associated with one or more geographic areas. In some examples, the map data can include a series of sub-maps, each sub-map including data for a geographic area including objects (e.g., buildings or other static features), paths of travel (e.g., roads, highways, public transportation lines, walking paths, and so on), parking lots and spaces, lanes and parking areas designated or dedicated for use by vehicle 500, and other features of interest. Navigation data store 380 can be used by the computing system 100 and/or server computing system 300 to provide navigational directions, perform point of interest searches, provide point of interest location or categorization data, determine distances, routes, or travel times between locations, or any other suitable use or task required or beneficial for performing operations of the example embodiments as disclosed herein. For example, the navigation data store 380 may store navigation information (e.g., route information, route histories, travel times, travel costs, delivery times, etc.) associated with orders for offerings where a delivery vehicle delivers the offerings in response to a request from a user. For example, the navigation data store 380 may store navigation information (e.g., route information, route histories, travel times, travel costs, etc.) associated with a vending vehicle such as vehicle 500 traveling to or between various regions to proactively provide offerings to users at the various regions. The navigation data store 380 may store information regarding a payload (inventory) of offerings associated with a delivery vehicle and a vending vehicle such as vehicle 500 which is associated with previously travelled routes. For example, the computing system 100 and/or server computing system 300 may use the information from the navigation data store 380 to route vehicle 500 along a best route (e.g., to regions having a highest exposure to customers, or regions having a highest sales yield, etc.) to optimally stock and/or fuel the vehicle 500 before sending the vehicle 500 out. For example, in response to receiving a request from a user of vehicle 500, the computing system 100 and/or server computing system 300 may reference information from the navigation data store 380 regarding vehicles having payloads that are similar to or identical to the payload of the vehicle 500 in determining an optimal route which satisfies criteria of a utility function.

Region information data store 390 may store or provide information about various regions to which vehicle 500 can travel which is accessible by the computing system 100 and/or server computing system 300. For example, the region information data store 390 may include information concerning a population density for various regions, information concerning a number of users in each region who have purchased or are likely to purchase offerings associated with the vehicle 500, information concerning past reactive and proactive shopping histories of users in each region, information concerning an amount of foot traffic in each region (e.g., a historical average, a real-time amount, etc.), and the like. For example, the region information data store 390 may include information regarding a historical or predicted profitability of a region, a historical or predicted amount of sales or revenue associated with a region, etc. For example, the region information data store 390 may include information regarding fuel or energy costs in a region, a tax rate associated with a region, parking costs in a region, etc. For example, the region information data store 390 may include information regarding real-time conditions of the region, such as a current time, weather, events occurring in the region, traffic conditions, an amount of people currently in the region, etc. For example, the computing system 100 and/or server computing system 300 may access or obtain information related to any events which may be occurring in various regions. For example, the computing system 100 and/or server computing system 300 may access or obtain information from the region information data store 390 and/or from external content 400 relating to events which could or have resulted in road closures or traffic jams and may adjust a navigation route of the vehicle 500 from one region to another, accordingly. In some implementations, the computing system 100 and/or server computing system 300 may provide navigation guidance for the vehicle 500 to a region having an event with a large gathering of people that are likely to purchase the offerings associated with the vehicle 500. The events may include concerts, movie showings, sporting events, etc., and the computing system 100 and/or server computing system 300 may optimize the arrival and departure times of the vehicle 500 to coincide with the start and end times of such events (e.g., appropriately buffered by some time interval to provide the offerings before and after the event). For example, if a football game is at 7 pm at a particular stadium and ends at 10 pm, the computing system 100 and/or server computing system 300 may be configured to determine that location as a region which is highly profitable (e.g., which satisfies criteria of a utility function) between 6:30 pm and 7:15 pm and between 9:45 pm and 10:30 pm, and treat these time periods appropriately when planning overall routing for the vehicle 500, for example, in advance, or in real-time.

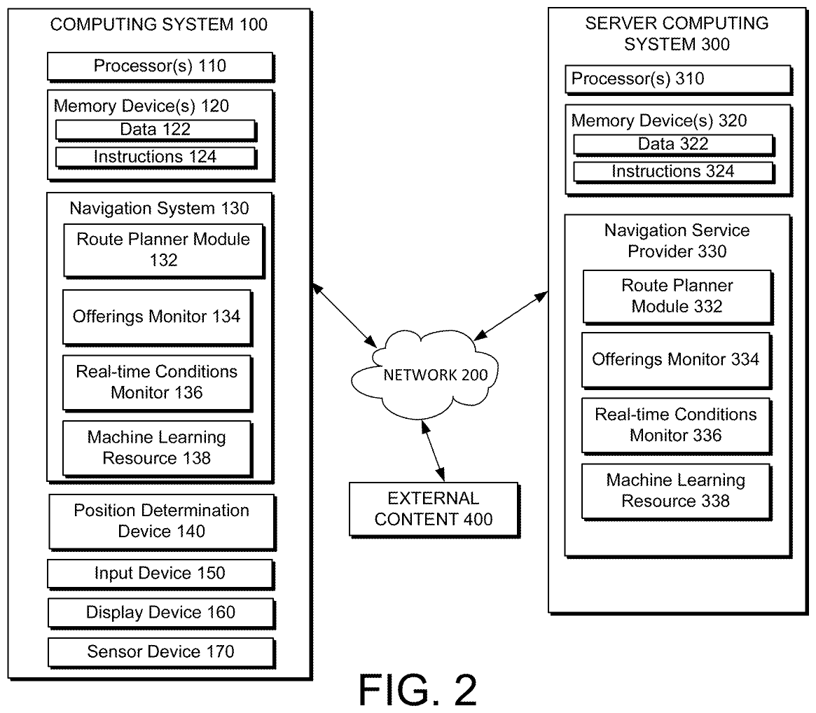

Referring now to FIG. 2, example block diagrams of a computing system and a server computing system according to one or more example embodiments of the disclosure will now be described.

As mentioned previously, computing system 100 may be an integrated on-board device of the vehicle 500 or may be separately provided (e.g., in the form of a smartphone or other portable electronic computing device) and connectable to the vehicle 500 via a wired or wireless network. The computing system 100 may include one or more processors 110, one or more memory devices 120, a navigation system 130, a position determination device 140, an input device 150, a display device 160, and a sensor device 170. The server computing system 300 may include one or more processors 310, one or more memory devices 320, and a navigation service provider 330.

For example, the one or more processors 110, 310 can be any suitable processing device that can be included in a computing system 100 or server computing system 300. For example, such a processor 110, 310 may include one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The one or more processors 110, 310 can be a single processor or a plurality of processors that are operatively connected, for example in parallel.

The one or more memory devices 120, 320 can include one or more non-transitory computer-readable storage mediums, such as such as a Read Only Memory (ROM), Programmable Read Only Memory (PROM), Erasable Programmable Read Only Memory (EPROM), and flash memory, a USB drive, a volatile memory device such as a Random Access Memory (RAM), a hard disk, floppy disks, a blue-ray disk, or optical media such as CD ROM discs and DVDs, and combinations thereof. However, examples of the one or more memory devices 120, 320 are not limited to the above description, and the one or more memory devices 120, 320 may be realized by other various devices and structures as would be understood by those skilled in the art.

For example, the one or more memory devices 120 can store instructions 124, that when executed, cause the one or more processors 110 to execute a route planner module 132 in connection with a machine learning resource 138 to identify or determine a region which satisfies criteria of a utility function with respect to offerings associated with the vehicle 500 and to provide navigation guidance for the vehicle 500 to the region, as described according to examples of the disclosure. The one or more memory devices 120 can also include data 122 and instructions 124 that can be retrieved, manipulated, created, or stored by the one or more processors 110. In some example embodiments, such data 122 can be accessed and used as input to execute the route planner module 132 in connection with the machine learning resource 138 to identify or determine a region which satisfies criteria of a utility function with respect to offerings associated with the vehicle 500 and to provide navigation guidance for the vehicle 500 to the region, as described according to examples of the disclosure.

For example, the one or more memory devices 320 can store instructions 324, that when executed, cause the one or more processors 310 to execute a route planner module 332 in connection with a machine learning resource 338 to identify or determine a region which satisfies criteria of a utility function with respect to offerings associated with the vehicle 500 and to provide navigation guidance for the vehicle 500 to the region, as described according to examples of the disclosure. The one or more memory devices 320 can also include data 322 and instructions 324 that can be retrieved, manipulated, created, or stored by the one or more processors 310. In some example embodiments, such data 322 can be accessed and used as input to execute the route planner module 332 in connection with the machine learning resource 338 to identify or determine a region which satisfies criteria of a utility function with respect to offerings associated with the vehicle 500 and to provide navigation guidance for the vehicle 500 to the region.

In some example embodiments, the computing system 100 includes a navigation system 130 for providing navigation guidance to the vehicle 500. The navigation system 130 can provide navigation services to a user. In some examples, the navigation system 130 can facilitate a user's access to a server computing system 300 that provides navigation services via navigation service provider 330. In some example embodiments, the navigation services include providing directions to a specific location such as a region or point-of-interest. For example, a user can input (e.g., via input device 150) a destination location (e.g., an address, a name of a region, a landmark, a venue, etc.). In response, the navigation system 130 can, using the position determination device 140, locally stored map data for a specific geographic area, and/or map data provided via the server computing system 300, provide navigation information allowing the user of the vehicle 500 or the vehicle 500 itself to navigate to the destination location. For example, the navigation information can include turn-by-turn directions from a current location (or a provided origin point or departure location) to the destination location. For example, the navigation information can include a travel time (e.g., estimated or predicted travel time) from a current location (or a provided origin point or departure location) to the destination region.

The navigation system 130 can provide, in a display device 160 of the computing system 100, a visual depiction of a geographic area or region. The visual depiction of the geographic area or region may include one or more streets, parking lots, sidewalks, designated lanes or parking areas for vending vehicles such as vehicle 500, one or more points of interest (including buildings, landmarks, and so on), and a highlighted depiction of a planned route. In some examples, the navigation system 130 can also provide location-based search options to identify one or more searchable points of interest within a given geographic area. In some examples, the navigation system 130 can include a local copy of the relevant map data including map data regarding various regions the vehicle 500 may travel to. In other examples, the navigation system 130 may access information at server computing system 300 which may be remotely located, to provide the requested navigation services.

In some examples, the navigation system 130 can include a dedicated application specifically designed to provide navigation services. In other examples, the navigation system 130 can be a general application (e.g., a web browser) and can provide access to a variety of different services including a navigation service via the network 200.

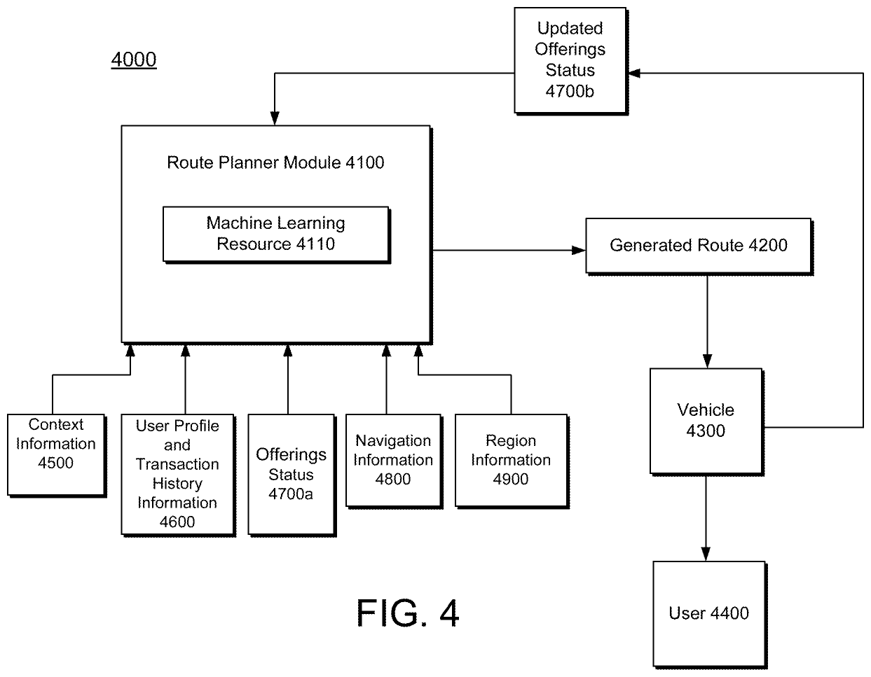

According to one or more aspects of the disclosure, the navigation system 130 can provide navigation guidance based on various inputs (e.g., inputs as shown in FIG. 4 including context information 4500, user profile and transaction history information 4600, offerings status 4700a, updated offerings status 4700b, navigation information 4800, and region information 4900) which the navigation system 130 can use to determine (e.g., using machine learning resource 138) a region among a plurality of regions which satisfies criteria of a utility function with respect to available offerings associated with the vehicle 500. In some examples, a user can input a request or input a query to the navigation system 130 to provide a navigation route to one or more regions satisfying the criteria of the utility function with respect to available offerings associated with the vehicle 500. In some examples, the navigation system 130 may automatically provide (e.g., in response to certain conditions or events) a navigation route to one or more regions satisfying the criteria of the utility function with respect to available offerings associated with the vehicle 500.

For example, the route planner module 132 may be configured to determine navigation guidance (e.g., a route) for the vehicle 500 by utilizing the machine learning resource 138 to determine whether the first region or another region (e.g., a second region) satisfies criteria of the utility function with respect to real-time conditions at various regions, for example, as monitored by the real-time conditions monitor 136 and the availability of the offerings associated with the vehicle 500, for example, as monitored by the offerings monitor 134. For example, the offerings monitor 134 may be configured to track an inventory of goods stocked by the vehicle 500 and may track an availability of services available via the vehicle 500 (e.g., in terms of a duration of time remaining for a service is to be provided). For example, the real-time conditions monitor 136 may be configured to track real-time conditions at a region the vehicle 500 is currently located at, regions that are on a planned route of the vehicle 500, as well as regions that the vehicle 500 is capable of traveling to. inventory of goods stocked by the vehicle 500 and may track an availability of services available via the vehicle 500 (e.g., in terms of a duration of time remaining for a service is to be provided). The real-time conditions obtained from each region may include a current time, weather, event scheduling, traffic conditions, etc. For example, the sensor device 170 may provide information to the real-time conditions monitor 136 regarding the real-time conditions of a surrounding environment of the vehicle 500. For example, the real-time conditions monitor 136 may obtain information regarding the real-time conditions of other regions via the server computing system 300 (e.g., via region information data store 390) and/or external content 400. For example, the real-time conditions monitor 136 may obtain information regarding the real-time conditions of other regions via sensor devices which are located at the various regions (e.g., from cameras disposed at the various regions, from smartphones disposed at the various regions, from noise sensors disposed at the various regions, from weather equipment disposed at the various regions, etc.).

In some implementations, the route planner module 132 may be configured to utilize the machine learning resource 138 to reevaluate a planned navigation route. For example, the route planner module 132 may be configured to utilize the machine learning resource 138 to reevaluate whether the first region or another region satisfies criteria of the utility function with respect to the current availability of the offerings, in response to at least one of the offerings being provided to one or more users at the first region. In some implementations, the route planner module 132 may be configured to utilize the machine learning resource 138 to reevaluate whether the first region or another region satisfies criteria of the utility function with respect to the current availability of the offerings, in response to the vehicle 500 remaining at the first region for a predetermined period of time. In some implementations, the route planner module 132 may be configured to utilize the machine learning resource 138 to reevaluate whether the first region or another region satisfies criteria of the utility function with respect to the current availability of the offerings, in response to a rate of the offerings being provided to one or more users at the first region per unit of time being less than a threshold level. In some implementations, the route planner module 132 may be configured to utilize the machine learning resource 138 to reevaluate whether the first region or another region satisfies criteria of the utility function with respect to the current availability of the offerings, in response to a request or query input via the input device 150 from a user associated with the vehicle 500.

In some example embodiments, the computing system 100 includes a position determination device 140. For example, position determination device 140 may be included in smartphone or portable computing device when the computing system 100 corresponds to the smartphone or the portable computing device separately provided from the vehicle 500. Position determination device 140 can determine a current geographic location of the computing system 100 and communicate such geographic location to navigation system 130, to server computing system 300 over network 200, or components of the vehicle 500 such as a navigation system of the vehicle 500 when the computing system 100 is separately provided from the vehicle 500. The position determination device 140 can be any device or circuitry for analyzing the position of the computing system 100. For example, the position determination device 140 can determine actual or relative position by using a satellite navigation positioning system (e.g. a GPS system, a Galileo positioning system, the GLONASS, the BeiDou Satellite Navigation and Positioning system), an inertial navigation system, a dead reckoning system, based on an IP address, by using triangulation and/or proximity to cellular towers or WiFi hotspots, and/or other suitable techniques for determining a position of the computing system 100.

The computing system 100 may include an input device 150 configured to receive an input from a user and may include, for example, one or more of a keyboard (e.g., a physical keyboard, virtual keyboard, etc.), a mouse, a joystick, a button, a switch, an electronic pen or stylus, a gesture recognition sensor (e.g., to recognize gestures of a user including movements of a body part), an input sound device or voice recognition sensor (e.g., a microphone to receive a voice command), a track ball, a remote controller, a portable (e.g., a cellular or smart) phone, a tablet PC, a pedal or footswitch, a virtual-reality device, and so on. The input device 150 may also be embodied by a touch-sensitive display device having a touchscreen capability, for example. According to some implementations, the input device 150 may be configured to receive a request or query from a user to provide navigation guidance for the vehicle 500 to one or more regions to provide the offerings associated with the vehicle 500. For example, a user may provide a natural language query via the input device 150 such as: “Tell me where to send my vehicle associated with goods A, B, and C and services D, E, and F, so they will sell quickly and at the best price.” The computing system 100 may utilize the navigation system 130 to find such a region or sequence of regions. As additional examples, the query from the user may specify a particular timeframe in which to provide all of the offerings associated with the vehicle (e.g., “Tell me a route to sell all of my ice cream in the next three hours”), or the user may specify a particular timeframe in which to provide a particular number of offerings associated with the vehicle (e.g., “Tell me a route where I can provide three haircuts in the next three hours”). As another example, the query from the user may request a particular timeframe and location in which to provide all of the offerings associated with the vehicle (e.g., “Tell me the best time today for me to sell my goods A, B, and C and where”). The computing system 100 may be configured to determine time(s) at which the vehicle 500 should arrive at a particular region, as well as a duration of time the vehicle should spend at the particular region before traveling to another region, if necessary.

The computing system 100 may include a display device 160 which displays information viewable by the user (e.g., a map). In some implementations, the display device 160 may be integrated with the vehicle 500, for example as part of an infotainment system of the vehicle 500. In some implementations, the display device 160 may be part of a smartphone when the computing system 100 is a portable device separate from the vehicle 500. For example, the display device 160 may be a non-touch sensitive display or a touch-sensitive display. The display device 160 may include a liquid crystal display (LCD), a light emitting diode (LED) display, an organic light emitting diode (OLED) display, active-matrix organic light emitting diode (AMOLED), flexible display, 3D display, a plasma display panel (PDP), a cathode ray tube (CRT) display, and the like, for example. However, the disclosure is not limited to these example displays and may include other types of displays. A graphical user interface for displaying a map and control various features thereof may be displayed on the display device 160. The graphical user interface may include features which enable a user to input a request or query for the computing system 100 to provide navigation guidance for the vehicle 500 to one or more regions to provide the offerings associated with the vehicle 500. The display device 160 can be used by the navigation system 130 installed on the computing system 100 to display navigational information to a user. Navigational information can include, but is not limited to, one or more of a map of a geographic area including various regions, the position of the computing system 100 (or vehicle 500) in the geographic area, a route through the geographic area designated on the map, one or more navigational directions (e.g., turn-by-turn directions through the geographic area), travel time for the route through the geographic area (e.g., from the position of the computing system 100 to a region), and one or more regions within the geographic area.

For example, the computing system 100 may include a sensor device 170 which detect various information. In some implementations, the sensor device 170 may be integrated with the vehicle 500, for example as part of a sensor system of the vehicle 500. In some implementations, the sensor device 170 may be part of a smartphone when the computing system 100 is a portable device separate from the vehicle 500. The sensor device 170 may include, for example, a camera or an imaging sensor (e.g., a complementary metal-oxide-semiconductor (CMOS) or charge-coupled device (CCD)) to detect or recognize a user's behavior, figure, expression, or the number of joint users, etc. The sensor device 170 may further include a brightness sensor to detect and recognize brightness information. The sensor device 170 may also include an accelerometer, an encoder, a gyroscope, and the like, to detect or recognize motion. The sensor device 170 may also include one or more sensors to detect or recognize environmental information (for example, a temperature sensor to detect or recognize temperature, a pressure sensor to detect or recognize pressure, a humidity sensor to detect or recognize humidity, etc.). The sensor device 170 may also include a force and/or torque sensor to detect or recognize a force and/or torque. The sensor device 170 may further include an audio sensor (e.g., a microphone) to recognize a voice of one or more users. The sensor device 170 may further include a navigation sensor (e.g., a GPS or INU) to obtain location information. The sensor device 170 may further include a clock for obtaining time information. The sensor device 170 may further include a touch sensor to detect or recognize a touch input. The sensor device 170 may also include a fingerprint recognition sensor, an iris recognition sensor, a depth sensor, a distance sensor, etc. However, the disclosure is not so limited and may include other types of sensors. Information obtained from the sensor device 170 may be used to determine real-time conditions such as to detect weather conditions, to detect a number of people in a region, to detect noise conditions, to detect traffic conditions, etc. Such information may be provided to the real-time conditions monitor 136, for example.

In accordance with example embodiments described herein, the server computing system 300 can include one or more processors 310 and one or more memory devices 320 which were previously discussed above. The server computing system 300 may also include a navigation service provider 330. For example, the navigation service provider 330 may include a route planner module 332, offerings monitor 334, real-time conditions monitor 336, and machine learning resource 338. Operations and functionality of the route planner module 332, offerings monitor 334, real-time conditions monitor 336, and machine learning resource 338, may be the same or similar to route planner module 132, offerings monitor 134, real-time conditions monitor 136, and machine learning resource 138, respectively. Therefore, discussion of these features will not be repeated for the sake of brevity.

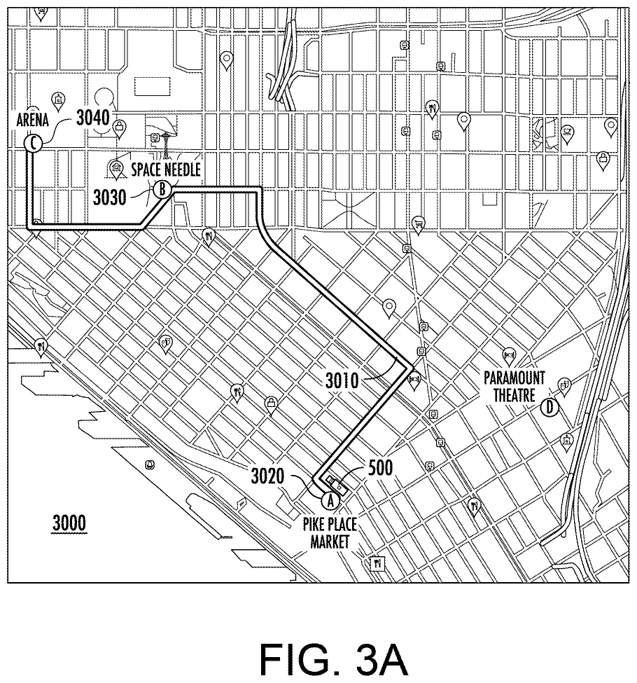

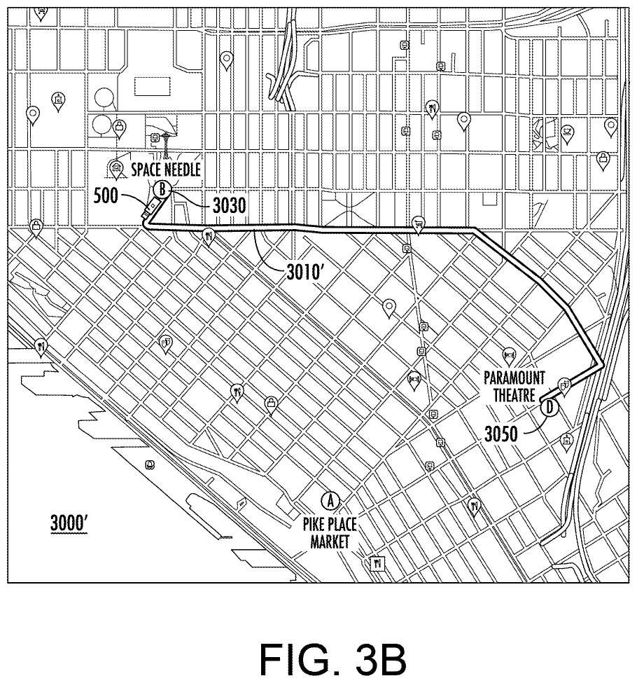

FIG. 3A depicts a first example route for distributing offerings associated with a vehicle, according to one or more examples of the disclosure. As illustrated in FIG. 3A, an example map 3000 (which may be presented on display device 160) includes a first navigation route 3010 which may be determined by route planner module 132. The first navigation route 3010 for vehicle 500 includes as a first destination a first region 3020 (annotated with the letter “A” in FIG. 3A), as a second destination a second region 3030 (annotated with the letter “B” in FIG. 3A), and as a third destination a third region 3040 (annotated with the letter “C” in FIG. 3A). The route planner module 132 may determine the first navigation route 3010 based on: (1) regions which are considered the busiest (e.g., having a high volume of people in the region, having high foot traffic in the region, having a high volume of people who consume the goods and services offered via the vehicle, etc.), (2) regions which are considered profitable (e.g., regions which are predicted to and/or have previously generated the highest revenue with respect to the goods and services associated with the vehicle, regions which are predicted to and/or have previously generated the highest profit with respect to the goods and services associated with the vehicle, etc.), (3) costs associated with traveling to each region along the route (e.g., fuel costs, taxation costs, costs associated with parking, etc.), (4) time considerations (e.g., the predicted time to travel to each region along the route while considering revenue and/profit which could be generated if not for the travel time, (5) real-time conditions such as a current time, weather, event scheduling in each region, traffic conditions, etc., and (6) past reactive and proactive shopping histories of users in each region.

Each of the first region 3020, second region 3030, and third region 3040 may correspond to a geographic area such as a road segment, a neighborhood, a parking lot, a specific address, a grid cell on a map (e.g., 1 km×1 km area), and the like. For example, some roads may include designated special lanes and some venues (e.g., concert halls, stadiums, schools, churches, etc.) may designate special parking areas for vending vehicles such as vehicle 500 to park. The route planner module 132 may include these designated areas as one of the plurality of regions to which the vehicle 500 may travel to in determining a navigation route. In some implementations, the machine learning resource 138 may be configured to give greater weight to regions such as specially designated areas located close to venues or specially designated lanes located along a road segment than other regions which are not specially designated for parking of vehicle 500.

FIG. 3B depicts a second example route for distributing offerings associated with a vehicle, according to one or more examples of the disclosure. As illustrated in FIG. 3B, an example map 3000′ (which may be presented on display device 160) includes a second navigation route 3010′ which may be determined by route planner module 132. The second navigation route 3010′ for vehicle 500 is an updated navigation route of the first navigation route 3010. For example, the computing system 100 may be configured to update the first navigation route 3010 while at second region 3030 or while traveling from second region 3030 to third region 3040. In the example of FIG. 3B, the route from second region 3030 to third region 3040 has been changed such that the vehicle 500 is provided navigation guidance to travel from second region 3030 to fourth region 3050 (annotated with the letter “D” in FIG. 3B).

In determining the first navigation route 3010, the route planner module 132 may determine or identify the first region 3020 among a plurality of regions as satisfying the criteria of the utility function and select the first region as the first destination. The route planner module 132 may determine the second region 3030 among the plurality of regions (other than the first region) as satisfying the criteria of the utility function (taking into account the expected transactions conducted and duration of time to be spent at the first region 3020) and select the second region 3030 as a second destination. The route planner module 132 may determine the third region 3040 among the plurality of regions (other than the first region 3020 and the second region 3030) as satisfying the criteria of the utility function (taking into account the expected transactions conducted and duration of time to be spent at the first region 3020 and second region 3030) and select the third region as a third destination, and so on to determine a route for the vehicle 500 by which the offerings associated with the vehicle can be provided given various constraints (e.g., a certain time period allotted for providing the offerings associated with the vehicle, an amount of fuel available for the vehicle, a minimum level of expected or predicted sales, a minimum level of expected or predicted profit, etc.). For example, the first region may be identified as satisfying the criteria of the utility function (e.g., by maximizing the utility function) when it is determined that the expected revenue or expected profit will be greatest by the vehicle 500 traveling to the first region compared to the other regions among the plurality of regions.

As discussed above, the route planner module 132 may be configured to dynamically recalculate or reevaluate the navigation route at any time based on a current or remaining availability of the offerings associated with the vehicle 500, based on real-time conditions and events, based on a rate of sales, etc. In addition, the route planner module 132 may be configured to dynamically recalculate or reevaluate a duration of time to be spent at each region at any time based on the current or remaining availability of the offerings associated with the vehicle, based on real-time conditions and events, based on a rate of sales, etc. Thus, the route planner module 132 may alter the previously planned sequence of destinations and/or the previously planned duration of time to be spent at each region, to satisfy the criteria of the utility function (e.g., maximize the utility function) according to real-time information available to the route planner module 132. For example, if a certain product becomes sold out or is below a threshold inventory level at the second region 3030 and a future region such as third region 3040 in the previously planned first navigation route 3010 was particularly responsive to that product, the route planner module 132 may be configured to determine the utility of visiting third region 3040 has sufficiently decreased such that the vehicle 500 no longer needs to stop there. Thus, the routing algorithm implemented by the route planner module 132 may recompute the navigation route to make any necessary least-cost updates to the route/schedule of the vehicle 500. The recomputing may occur at various times—for example, each time a product is provided, each time the vehicle leaves a region, at predetermined time intervals, etc. For example, in FIG. 3B the route planner module 132 has recomputed or updated the navigation route to second navigation route 3010′ such that fourth region 3050 is a next-scheduled region for vehicle 500 to visit rather than third region 3040. For example, the machine learning resource 138 may predict that traveling to the fourth region 3050 to provide offerings to users at the fourth region 3050 is likely to be more profitable than traveling to the third region 3040 among the plurality of regions.

In some implementations, the route planner module 132 may be configured to determine in real-time a region (e.g., an optimal region) among the plurality of regions which satisfies the criteria of the utility function: (1) in response to an offering being provided via the vehicle 500, (2) at periodic intervals, (3) in response to the vehicle 500 remaining at a region for a duration of time greater than a predetermined duration of time, (4) in response to a rate of the offerings being provided to one or more users at a region per unit of time being less than a threshold level (e.g., if revenue is not being generated after a predetermined amount of time at a region, a number of product offerings sold per some unit of time is less than a threshold sales level, if an amount of revenue or profit earned per some unit of time is less than a threshold revenue/profit level, etc.), etc.

Thus, the route planner module 132 may be configured to subsequently determine whether the criteria of the utility function will continue to be satisfied by remaining at a particular region (the second region 3030) or by traveling to another region (e.g., the third region 3040 or fourth region 3050) among the plurality of regions with respect to an availability of the offerings associated with the vehicle 500. When the second region 3030 is identified as the region which satisfies the criteria of the utility function based on real-time conditions at the second region 3030 and the third region 3040 or fourth region 3050, and based on the availability of the offerings, navigation guidance may be provided for the vehicle 500 to the third region 3040 or fourth region 3050 (e.g., via a navigation device). When the second region 3030 is identified as the region which satisfies the criteria of the utility function, the vehicle 500 may remain at the second region 3030.

Referring to FIG. 4, an example flow diagram for generating a route for distributing offerings associated with a vehicle is shown, according to one or more examples of the disclosure. The flow diagram 4000 of FIG. 4 represents operations and functions capable of being performed by the navigation system 130, the navigation service provider 330, and combinations thereof. For example, the route planner module 4100 may correspond to route planner module 132 and/or route planner module 332. For example, the machine learning resource 4110 may correspond to machine learning resource 138 and/or machine learning resource 338. For example, the vehicle 4300 may correspond to vehicle 500.

As shown in FIG. 4, the route planner module 4100 may receive one or more inputs including context information 4500, user profile and transaction history information 4600, offerings status 4700a, updated offerings status 4700b, navigation information 4800, and region information 4900. The route planner module 4100 may utilize the machine learning resource 4110 to determine a region (e.g., an optimal region) among a plurality of regions which satisfies criteria of a utility function, based on the one or more inputs. That is, the route planner module 4100 may be configured to utilize the machine learning resource 4110 to determine region which satisfies (or is predicted to satisfy) the criteria of the utility function based on information previously collected, information collected in real-time, and information which is predicted or expected.

For example, the context information 4500 may correspond to information accessible from the contextual information data store 360, the user profile and transaction history information 4600 may correspond to information accessible from the user profile data store 350 and the user transaction history information data store, offerings status 4700 and updated offerings status 4700b may correspond to information received from offerings monitor 134 or offerings monitor 334, navigation information 4800 may correspond to information accessible from the navigation data store 380, and region information 4900 may correspond to information accessible from the region information data store 390.

For example, the route planner module 4100 and machine learning resource 4110 may leverage information which is collected concerning reactive transactions as well as concerning proactive transactions, to determine a route in response to a query from a user or in response to some other condition or criteria. For example, the user profile and transaction history information 4600 and/or navigation information 4800 may include route histories to route vehicles along the best routes (e.g., having the highest exposure to customers, or having the highest sales yield, etc.). For example, the user profile and transaction history information 4600 and/or navigation information 4800 may include information concerning route histories for vehicles having particular payloads that are similar to or identical to a payload of the vehicle 500 or are similar to or identical to an inventory of a user who wishes to optimally stock and/or fuel a vehicle 500 before sending the vehicle 500out. For example, the user profile and transaction history information 4600 and/or navigation information 4800 may include may also include information about past order deliveries of vehicles, including payload information, pricing information, delivery time information, delivery success/failure information, travel time information, etc. Such information may then be aggregated by region (which may correspond to a road segment, neighborhood, grid cell, etc., as discussed above), and categorized (e.g., by product category, by time, by brand, etc.). The route planner module 4100 and machine learning resource 4110 may then leverage some or all of the above-described information to determine a route for the vehicle 500 so as to satisfy the criteria of the utility function (e.g., by optimizing an exposure to customers, by maximizing an expected revenue and/or profit, etc.), with respect to the offerings associated with the vehicle 500.

The machine learning resource 4110 may be configured to implement various algorithms to determine a navigation route which satisfies the criteria of the utility function (e.g., maximizes the utility function) with respect to the distribution of offerings provided via the vehicle 500. In some implementations, the machine learning resource 4110 may be configured to determine a route in a “greedy” algorithm fashion. For example, in the case of providing advertising services via the vehicle 500, the algorithm may be implemented to achieve a highest exposure, enforcing some minimum exposure time at a region and taking into account the diminishing returns of overstaying at a particular region, with the overall benefit computed as the sum of the products of the number of people P and a marginal utility function of the number of minutes of exposure to them (i.e., being in the vicinity of N meters to each predicted population Pi): Sum (Pi*U (Ti)). In the case of providing goods via the vehicle 500, the algorithm may be implemented to optimize for the highest likely sales total (e.g., maximizing revenue, maximizing profit, etc.), which also depends on the exposure time (i.e., when the vehicle 500 is in a non-moving parked state) and takes into account the diminishing returns of overstaying at the same location. The utility function in each case can then be computed based on the total sales of similar products at or near the region and, over time, can also be based on previous sales from the vehicle 500 (or other similar vending vehicles).

The computing system 100 may be configured to store (e.g., in the one or more memory devices 120 or an external database, etc.) a mapping of products to a market segment formed by customers likely to purchase these products. Thus, the machine learning resource 4110 can determine which products sell best in particular regions such as near university campuses, retirement homes, movie theatres, etc. For example, the market at some regions may be segmented by brand/product, and the utility function may include different weighted components for each individual product brand or category, and, therefore, the routing algorithm implemented by the machine learning resource 4110 may factor this in and re-evaluate the expected utility of stopping at each future region after visiting a region and update the route dynamically as the product inventory of the vehicle 500 changes.

The computing system 100 also can store (e.g., in the one or more memory devices 120 or an external database, etc.) a mapping of an expected or measured number of customers with respect to particular regions based on knowledge of traffic patterns, any special events occurring at each region, a time of day (e.g., times when students are released from school or when people travel to work or home). For example, the machine learning resource 4110 can predict a number of people expected to be at a particular region based on previous data in a similar context (e.g., a similar time of day, weather, etc.) or social media information, or the computing system 100 can be configured to measure a number of people at a particular region based on real-time data such as from data obtained from one or more cameras at the region which can capture images of people located at the region, or from information obtained from mobile devices such as smart phones carried by people in the region that can indicate a number of people at the region (e.g., as part of context information 4500 and/or region information 4900).

The machine learning resource 4110 may be configured to analyze various regions that the vehicle 500 can possibly travel to and determine an optimal route for the vehicle 500 to travel along to satisfy certain utility function criteria with respect to the distribution of offerings associated with the vehicle. For example, existing information regarding user transactions (e.g., from the user profile and transaction history information 4600) may be aggregated as discussed above on a region-by-region basis (e.g., by grid cells of a certain size or by road segment), and broken down by brand, category, etc. Further breakdowns of the transactions may be categorized by time of day, day of week, weekday/weekend, month, etc. so that the machine learning resource 4110 can determine a route based on time dependent variations. In some implementations the routing algorithm utilized by the machine learning resource 4110 may be greedy or an approximation to a traveling salesman problem or a max-flow problem (e.g., for cases with labeled road segments compared to region cells/nodes). The machine learning resource 4110 may determine an amount of time to stay at a region based on various information such as a volume of previous sales at the region (user profile and transaction history information 4600), a weather forecast for the region (context information 4500), event information pertaining to the region (region information 4900), traffic information such as road closures (navigation information 4800), a current availability of offerings (offering status 4700a or updated offerings status 4700b), etc. The machine learning resource 4110 may also factor in a fixed amount of time per expected transaction at the region when determining the amount of time to stay at a region. Each region among a plurality of regions considered by the machine learning resource 4110 for determining a navigation route of the vehicle 500 has both a time cost and an associated sales parameter (e.g., revenue, profit, etc.) which itself is a function of time. The route planner module 4100 may utilize the machine learning resource 4110 to plan a route for the vehicle 500 to visit a sequence of regions for as long as the derivative (or the second derivative) of sales with respect to time is above a certain threshold. That is, the machine learning resource 4110 may determine that the criteria of a utility function are satisfied (e.g., by maximizing the utility function) so long as an instantaneous increase, or rate of increase, in revenue is above a threshold value. The threshold value may initially be set to some fixed value that is predicted to guarantee at least a minimum duration of time at a region, and then be calibrated empirically based on the known transaction times and time intervals between transactions.

The route planner module 4100 is configured to output a navigation route (generated route 4200) and navigation guidance is provided to vehicle 4300. The vehicle 4300 may travel to a region along the navigation route and provide one or more offerings to user 4400. In response to one or more offerings being provided to a user 4400, an updated offerings status 4700b may be provided to the route planner module 4100. In some implementations, the route planner module 4100 may be configured to reevaluate or recompute a navigation route in response to receiving the updated offerings status 4700b.

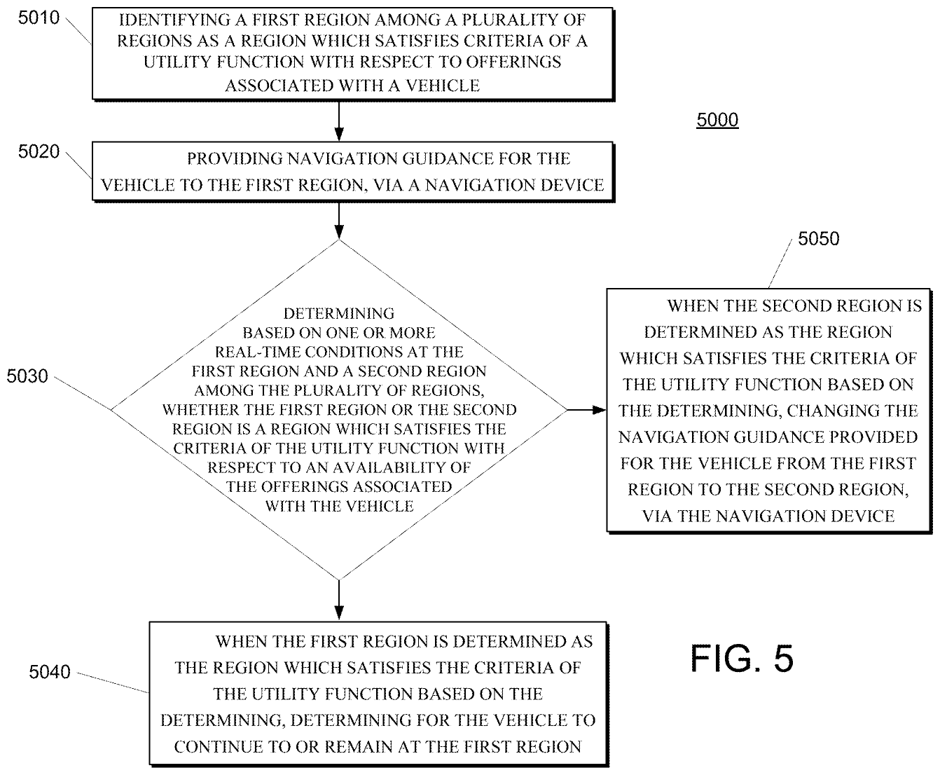

Referring to FIG. 5, in an example computer implemented method 5000 at operation 5010 the method includes identifying a first region among a plurality of regions as a region which satisfies criteria of a utility function with respect to offerings associated with a vehicle. For example, the computing system 100 and/or server computing system 300 may utilize a machine learning resource (e.g., machine learning resource 4110) which receives various inputs (e.g., context information 4500, user profile and transaction history information 4600, offerings status 4700a, updated offerings status 4700b, navigation information 4800, and region information 4900) which determines the first region as a region among a plurality of regions which satisfies criteria of the utility function with respect to offerings associated with the vehicle 500 (e.g., the first region may be determined or predicted to be a region which is likely to be most profitable or to receive the most exposure).

At operation 5020 the method further includes providing navigation guidance for the vehicle to the first region, via a navigation device. For example, a navigation system of the vehicle 500 may provide navigation guidance for the vehicle 500 to the first region using the position determination device 530. For example, the computing system 100 (which may be separately provided from a navigation system of the vehicle 500) may provide navigation guidance for the vehicle 500 to the first region (e.g., using information from the navigation data store 380) via a navigation device such as a GPS device, an antenna, and the like. For example, the server computing system 300 may provide navigation guidance for the vehicle 500 to the first region (e.g., using information from the navigation data store 380) via a navigation device such as a GPS device, an antenna for a wireless network, and the like.

At operation 5030 the method further includes determining, based on one or more real-time conditions at the first region and a second region among the plurality of regions, whether the first region or the second region is a region which satisfies the criteria of the utility function with respect to an availability of the offerings associated with the vehicle. For example, the computing system 100 and/or server computing system 300 may utilize a machine learning resource (e.g., machine learning resource 4110) which receives various inputs (e.g., context information 4500, user profile and transaction history information 4600, offerings status 4700a, navigation information 4800, and region information 4900) relating to the real-time conditions of various regions and a current availability of the offerings associated with the vehicle 500. The computing system 100 and/or server computing system 300 may utilize the machine learning resource to determine whether the first region or another region (a second region) satisfies criteria of the utility function with respect to the current availability of the offerings associated with the vehicle 500 (e.g., the first region or another region may be determined or predicted to be a region which is likely to be most profitable or to receive the most exposure based on the current availability of the offerings). For example, operation 5030 may be performed while the vehicle 500 is at the first region or while the vehicle 500 is proceeding to the first region. For example, an unexpected traffic jam or road closure may cause the computing system 100 and/or server computing system 300 to reevaluate whether the first region or another region satisfies criteria of the utility function with respect to the current availability of the offerings associated with the vehicle 500. In some implementations, the computing system 100 and/or server computing system 300 are configured to reevaluate whether the first region or another region satisfies criteria of the utility function with respect to the current availability of the offerings in response to at least one of the offerings being provided to one or more users at the first region. In some implementations, the computing system 100 and/or server computing system 300 are configured to reevaluate whether the first region or another region satisfies criteria of the utility function with respect to the current availability of the offerings in response to the vehicle remaining at the first region for a predetermined period of time. In some implementations, the computing system 100 and/or server computing system 300 are configured to reevaluate whether the first region or another region satisfies criteria of the utility function with respect to the current availability of the offerings in response to a rate of the offerings being provided to one or more users at the first region per unit of time being less than a threshold level. The unit of time may be any unit of time, for example, in terms of minutes, hours, etc. In some implementations, the computing system 100 and/or server computing system 300 are configured to reevaluate whether the first region or another region satisfies criteria of the utility function with respect to the current availability of the offerings in response to a request or query from a user associated with the vehicle 500.

At operation 5040 the method further includes, when the first region is determined as the region which satisfies the criteria of the utility function based on the determining, determining for the vehicle to continue to or remain at the first region. For example, the computing system 100 and/or server computing system 300 may inform a user of the vehicle 500 or inform the vehicle 500 itself to remain at the first region when the vehicle is at the first region at operation 5030. For example, the computing system 100 and/or server computing system 300 may inform a user of the vehicle 500 or inform the vehicle 500 itself to continue to the first region when the vehicle is in the process of proceeding to the first region at operation 5030.

At operation 5050 the method further includes, when the second region is determined as the region which satisfies the criteria of the utility function based on the determining, changing the navigation guidance provided for the vehicle from the first region to the second region, via the navigation device. For example, a navigation system of the vehicle 500 may change the navigation guidance for the vehicle 500 from the first region to the second region using the position determination device 530. For example, the computing system 100 (which may be separately provided from a navigation system of the vehicle 500) may provide navigation guidance for the vehicle 500 to the second region (e.g., using information from the navigation data store 380) via a navigation device such as a GPS device, an antenna, and the like. For example, the server computing system 300 may provide navigation guidance for the vehicle 500 to the second region (e.g., using information from the navigation data store 380) via a navigation device such as a GPS device, an antenna for a wireless network, and the like.

To the extent that terms such as “module”, and “unit,” are used herein (e.g., in connection with the route planner module 132 and route planner module 332), such terms may refer to, but are not limited to, a software or hardware component or device, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Aspects of the above-described example embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks, Blue-Ray disks, and DVDs; magneto-optical media such as optical discs; and other hardware devices that are specially configured to store and perform program instructions, such as semiconductor memory, read-only memory (ROM), random access memory (RAM), flash memory, USB memory, and the like. Examples of program instructions include both machine code, such as produced by a compiler, and files containing higher level code that may be executed by the computer using an interpreter. The program instructions may be executed by one or more processors. The described hardware devices may be configured to act as one or more software modules in order to perform the operations of the above-described embodiments, or vice versa. In addition, a non-transitory computer-readable storage medium may be distributed among computer systems connected through a network and computer-readable codes or program instructions may be stored and executed in a decentralized manner. In addition, the non-transitory computer-readable storage media may also be embodied in at least one application specific integrated circuit (ASIC) or Field Programmable Gate Array (FPGA).

Each block of the flowchart illustrations may represent a unit, module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently (simultaneously) or the blocks may sometimes be executed in the reverse order, depending upon the functionality involved.

While the disclosure has been described with respect to various examples, each example is provided by way of explanation, not limitation of the disclosure. Those skilled in the art, upon attaining an understanding of the foregoing, can readily produce alterations to, variations of, and equivalents to such embodiments. Accordingly, the disclosure does not preclude inclusion of such modifications, variations and/or additions to the disclosed subject matter as would be readily apparent to one of ordinary skill in the art. For example, features illustrated or described as part of one embodiment can be used with another embodiment to yield a still further embodiment. Thus, it is intended that the disclosure covers such alterations, variations, and equivalents.

What is claimed is:

1. A method, comprising:
identifying a first region among a plurality of regions as a region which satisfies criteria of a utility function with respect to offerings associated with a vehicle;
providing navigation guidance for the vehicle to the first region, via a navigation device;
determining, based on one or more real-time conditions at the first region and a second region among the plurality of regions, whether the first region or the second region is a region which satisfies the criteria of the utility function with respect to an availability of the offerings associated with the vehicle; and
when the second region is determined as the region which satisfies the criteria of the utility function based on the determining, changing the navigation guidance provided for the vehicle from the first region to the second region, via the navigation device.

2. The method of claim 1, further comprising, when the first region is determined as the region which satisfies the criteria of the utility function based on the determining, determining for the vehicle to continue to or remain at the first region.

3. The method of claim 1, further comprising:
when the second region is determined as the region which satisfies the criteria of the utility function based on the determining, autonomously controlling the vehicle to navigate to the second region; and
when the first region is determined as the region which satisfies the criteria of the utility function based on the determining, autonomously controlling the vehicle to remain at the first region.

4. The method of claim 1, further comprising:
determining a navigation route which sequentially passes through two or more regions among the plurality of regions, wherein each of the two or more regions are determined as regions among the plurality of regions as regions which satisfy the criteria of the utility function with respect to the availability of the offerings associated with the vehicle based on a first sequence of travel; and
in response to at least one of the offerings being provided to one or more users at one of the two or more regions, determining whether to change the navigation route to a second sequence of travel based on a remaining availability of the offerings associated with the vehicle.

5. The method of claim 4, further comprising:
when the remaining availability of the offerings associated with the vehicle is below a threshold level, determining to change the navigation route to the second sequence of travel.

6. The method of claim 1, wherein whether the criteria of the utility function is satisfied is based on at least one of an expected profit to be obtained at each region among the plurality of regions per unit of a predetermined period of time, an expected revenue to be obtained at each region among the plurality of regions per unit of the predetermined period of time, a cost associated with traveling to each region among the plurality of regions, or a cost associated with remaining in each region among the plurality of regions for the predetermined period of time.

7. The method of claim 1, wherein the one or more real-time conditions include at least one of current traffic conditions on one or more routes from the first region to the second region, current weather conditions at each of the first region and the second region, current events occurring at each of the first region and the second region, a current predicted consumer population density at each of the first region and the second region, or current foot traffic conditions at each of the first region and the second region.

8. The method of claim 1, wherein the plurality of regions correspond to one or more road segments in a predefined area, one or more grid cells associated with a map of the predefined area, or one or more locations at which the vehicle is permitted to provide the offerings to one or more users.

9. The method of claim 1, further comprising, in response to the vehicle remaining at the first region for a predetermined period of time, determining based on the one or more real-time conditions at the first region and the second region, whether the first region or the second region is a region which satisfies the criteria of the utility function with respect to the availability of the offerings associated with the vehicle.

10. The method of claim 1, wherein the offerings include at least one of goods or services, and
the method further comprises providing the at least one of the goods or services to one or more users at the first region by:
when the offerings include one or more goods, in response to a selection of the one or more goods via a user interface, causing the vehicle to dispense the one or more goods to the one or more users, or
when the offerings include one or more services, in response to a selection of the one or more services via the user interface, causing the vehicle to authorize the one or more services to be performed for the one or more users.

11. The method of claim 1, wherein, in response to a rate of the offerings being provided to one or more users at the first region per unit of time being less than a threshold level, determining whether the first region or the second region is a region which satisfies the criteria of the utility function with respect to the availability of the offerings associated with the vehicle.

12. The method of claim 1, wherein identifying the first region is based on a history of instances of providing the offerings to users at the first region.

13. A computing system, comprising:
one or more memories to store instructions; and
one or more processors configured to execute the instructions stored in the one or memories to:
identify a first region among a plurality of regions as a region which satisfies criteria of a utility function with respect to offerings associated with a vehicle,
provide navigation guidance for the vehicle to the first region, via a navigation device,
determine, based on one or more real-time conditions at the first region and a second region among the plurality of regions, whether the first region or the second region is a region which satisfies the criteria of the utility function with respect to an availability of the offerings associated with the vehicle, and
when the second region is determined as the region which satisfies the criteria of the utility function based on the determination, change the navigation guidance provided for the vehicle from the first region to the second region, via the navigation device.

14. The computing system of claim 13, wherein the one or more processors are configured to, when the first region is determined as the region which satisfies the criteria of the utility function, determine for the vehicle to continue to or remain at the first region.

15. The computing system of claim 13, wherein the one or more processors are configured to:
when the second region is determined as the region which satisfies the criteria of the utility function based on the determination, autonomously control the vehicle to navigate to the second region, and
when the first region is determined as the region which satisfies the criteria of the utility function based on the determination, autonomously control the vehicle to remain at the first region.

16. The computing system of claim 13, wherein the one or more processors are configured to:
determine a navigation route which sequentially passes through two or more regions among the plurality of regions, wherein each of the two or more regions are determined as regions among the plurality of regions as regions which satisfy the criteria of the utility function with respect to the availability of the offerings associated with the vehicle based on a first sequence of travel, and
in response to at least one of the offerings being provided to one or more users at one of the two or more regions, determine whether to change the navigation route to a second sequence of travel based on a remaining availability of the offerings associated with the vehicle.

17. The computing system of claim 16, wherein the one or more processors are configured to, when the remaining availability of the offerings associated with the vehicle is below a threshold level, determine to change the navigation route to the second sequence of travel.

18. The computing system of claim 13, wherein the one or more processors are configured to:
in response to receiving a query from a user requesting a route to distribute a set amount of offerings stocked in the vehicle in a set duration of time, determine based on the one or more real-time conditions at the first region and the second region, whether the first region or the second region is a region which satisfies the criteria of the utility function with respect to the query, and
determine a route for the vehicle to one of the first region or the second region, based on the determination with respect to the query.

19. The computing system of claim 13, wherein the one or more processors are configured to:
in response to the vehicle remaining at the first region for a predetermined period of time, determine based on the one or more real-time conditions at the first region and the second region, whether the first region or the second region is a region which satisfies the criteria of the utility function with respect to the availability of the offerings associated with the vehicle, and
in response to a rate of the offerings being provided to one or more users at the first region per unit of time being less than a threshold level, determine based on the one or more real-time conditions at the first region and the second region, whether the first region or the second region is a region which satisfies the criteria of the utility function with respect to the availability of the offerings associated with the vehicle.

20. A vehicle, comprising:
a navigation device; and
a computing system configured to:
identify a first region among a plurality of regions as a region which satisfies criteria of a utility function with respect to offerings associated with the vehicle,
provide navigation guidance for the vehicle to the first region, via the navigation device,
determine, based on one or more real-time conditions at the first region and a second region among the plurality of regions, whether the first region or the second region is a region which satisfies the criteria of the utility function with respect to an availability of the offerings associated with the vehicle, and
when the second region is determined as the region which satisfies the criteria of the utility function based on the determination, change the navigation guidance provided for the vehicle from the first region to the second region, via the navigation device.
